(19) United States
(12) Patent Application Publication
(10) Pub. No.: US 2016/0196102 A1
(43) Pub. Date: Jul. 7, 2016

(54) SYSTEM FOR HANDHELD PORTABLE HIGH FIDELITY MUSIC PLAYBACK WITH STREAMING AND WIFI ROUTING ABILITY

(71) Applicant: Changzhi Yao, Shenzhen (CN)

(72) Inventor: Changzhi Yao, Shenzhen (CN)

(21) Appl. No.: 14/590,713

(22) Filed: Jan. 6, 2015

(51) Int. Cl. G06F 3/16; H04W 76/00; H04W 4/06; H04R 3/12; G10L 19/00

(52) U.S. Cl. CPC G06F 3/165; H04R 3/12; G10L 19/0017; H04W 4/06; H04W 76/002

(57) ABSTRACT

A system for a portable audio data processing device having a rotatable knob for inputting user commands, and an interface and a plurality of functional components installed on this portable audio data processing device that respond to said knob's rotation, wherein said plurality of functional components include functional components for controlling of Wi-Fi connections, searching the internet, and controlling of audio output devices, and for decoding and encoding high fidelity audio data into data format that is suitable a chosen sound system by the user.

### CROSS REFERENCE

Priority is claimed from the U.S. Provisional Patent Application No. 61/924184 filed on Jan. 6, 2014 entitled “Handheld Portable High Fidelity Music Playback with Streaming and Wi-Fi Routing Ability”, the entirety of which is hereby incorporated by reference.

### BACKGROUND OF THE INVENTION

1. Field of the Invention

The present invention relates to a controlling system for high fidelity music playbacks, more particularly, relates to a system that renders portable high fidelity music processing and playbacks, and that forms a wireless routing network with various electronic devices, enabling seamless music and media streaming with the internet and high fidelity lossless sound effect to cell phones, tablets, earphones, car sound systems, family entertainment centers and power speakers.

2. Description of the Related Art

The proprietary protocol AIRPLAY™ developed by Apple Inc allows wireless digital streaming of audio, video, and photos between devices connected in a Apple device network. There are two types of AIRPLAY™ devices: those that send audiovisual content, and those capable of receiving the content and rendering it on displays and speakers. AIRPLAY™ sender devices include computers running ITUNEs, and IOS devices such as IPHONEs, and IPADs running IOS4.2 or greater. AIRPLAY™ receiver devices (e.g. AIRPORT EXPRESS) usually have an audio output connector that also sends stream signals to other devices, Apple TV, and AIRPLAY™ enabled third party speakers.

Using AIRPLAY™ protocol, a user can play media from a single AIRPLAY™-cornpatible source, like an IPAD or IPHONE, and stream it to multiple AIRPLAY™-compatible devices on the same Apple device network, including TVs and stereo systems, AIRPLAY™ thus turns an IPHONE or IPAD into music sound system remote control, allowing great freedom for music lovers to connect to the unlimited internet music sources.

The Digital Living Network Alliance (DLNA) establishes guidelines specifying a set of standards to achieve interoperability for PC and ANDOID operating systems. However, AIRPLAY™ is incompatible with PC or ANDROID™ based devices. PC and ANDROID™ users would not be able to have much of the entertainment and fun provided by Apple products, vice versa for Apple users.

The DLNA guidelines apply a layer of restrictions over the types of media file format, encodings and resolutions that a device must support. As of 2013, over 18,000 different device models have obtained “DLNA Certified” status confirming their interoperability with other devices. An estimated more than 440 million DLNA-certified devices, from digital cameras to game consoles and TVs, were installed in users' homes.

Many users need to own both Apple products and PC or ANDOID™ based systems while many other music lovers who own expensive family theatric sound systems that do not network with neither AIRPLAY™ devices nor the DLNA devices still need to find a. solution,

On the other hand, current portable computer systems, smart phones, tablets or other handheld computer systems do not have the capacity to process high resolution music data having depth higher than 16 bit. The quality and sound effect of compressed audio data may not be good enough for many music lovers.

The current high fidelity sound systems are so expensive that many people do not ever dare to dream about listening to high fidelity music. All of the car drivers would not have dreamed of listening to high fidelity music.

Technology illiterate or pre-school children, the un-educated, the illiterate, and people with old age and disabilities would not be able to enjoy the current high technology based music systems.

Accordingly, there is great need for an improved portable audio system that is easy to use even for technology ignorant consumers and at the same time that can handle high density audio data and also plays back such audio data in high quality and lossless way.

### ASPECTS AND SUMMARY OF THE INVENTION

This application discloses a system that enables a portable handheld device to receive high resolution audio data through Wi-Fi transmission in either AIRPLAY™ or DLNA formal, and to process and playback the audio data in high fidelity.

In one embodiment, it is provided an Android Operating System based user interface and system that receives audio data streams transmitted in either AIRPLAY or DLNA compliant format and decodes them into a 24 bit 192 k DAC (Digital to Analog Converter) or S/PDIF (Sony/Philips Digital Interface Format) audio format for lossless playback in built-in or external audio systems.

In one embodiment, it is provided an Android Operating System based user interface and system that transmits 24 bit 192 k DAC (Digital to Analog) or S/PDIF (Sony/Philips Digital Interface Format) digital audio data through Wi-Fi wireless transmission, enabling complete media sharing between all wireless enabled digital music players.

In one embodiment it is provided an Android Operating System based user interface and system that detects a user's mechanic input signal through a traditional low-tech rotating knob like the one on a radio, as well as a touch screen, and corresponds such user input signal with internet music channels, allowing the most technology illiterate users, pre-school children, the un-educated, the illiterate, and people with old age and disabilities to enjoy lossless music from the internet.

The above and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 is an example diagram of functional interactions between a portable audio processing system and various music sources and play devices in accordance with this application.

FIG. 2A and 2B are respectively a side view and a top view of an example portable audio processing system having a radio-like rotating knob and a touch-screen display in accordance with this application.

FIG. 3 is an example audio signal processing flow chart in accordance with this application.

FIG. 4 is an example audio data transmission process in accordance with this application.

FIG. 5 is an example audio data decoding processing flow chart of a high resolution music stream or media stream in accordance to this application.

FIG. 6 is an example built-in high fidelity amplifying mechanism for earphones in accordance to this application.

### DETAILED DESCRIPTION OF SAMPLE EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

The present invention may be described herein in terms of functional block components and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, Java, COBOL, assembler, PERL, PHP, javascript, C-Objective, or the like, with the various algorithms being implemented with any combination of data structures, objects, processes, routines, or other programming elements. Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Furthermore, the connecting lines shown in the various figures contained herein are intended to represent exemplary functional relationships and/or physical couplings between the various elements. It should be noted that many alternative or additional functional relationships or physical connections may be present in a practical incentive system implemented in accordance with the invention.

Communication between device participants in the audio network system of the present invention is accomplished through any suitable communication means, such as, for example, a telephone network, public switch telephone network, intranet, Internet, extranet, WAN, LAN, WLAN, personal digital assistant, cellular phone, kiosk terminal, online communications, off-line communications, wireless communications, satellite communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

It further will be appreciated that the portable audio device users may interact with various devices in the network such as a keyboard, mouse, kiosk, personal digital assistant, handheld computer (iPad, iPod, etc.), cellular phone, and/or the like. Similarly, the invention could be used in conjunction with any type of personal computer, network computer, workstation, minicomputer, mainframe, or the like, running any operating system, such as any version of Windows, Windows NT, Windows 2000, Windows 98, Windows 95, MacOS, iOS, BeOS, Linux, UNIX, Android, or the like. The Wi-Fi Alliance defines Wi-Fi as any “wireless local area network” (WLAN) products that are based on the Institute of Electrical and Electronics Engineers' (IEEE) 802.11 standards.

The network may be a public network, which is assumed to be insecure and open to eavesdroppers. In one embodiment, the network is embodied as the Internet.

As will be appreciated by one of ordinary skill in the art, the present invention may be embodied as a method, a data processing system, a device for data processing, and/or a computer program product. Accordingly, aspects of the present invention may take the form of an entirely software embodiment, an entirely hardware embodiment, or combining aspects of both software and hardware embodiment. Furthermore, the present invention may take the font of a computer program product on a computer-readable storage medium having computer-readable program-code means embodied in the storage medium. Any suitable computer-readable storage medium may be utilized, including hard disks, CD-ROM, optical storage devices, flash drives, cloud server, magnetic storage devices, and/or the like.

The present invention is described below with reference to block diagrams and flowchart illustrations of methods, apparatus (e.g., systems), and computer program, components, products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

The term “wireless” as used herein with respect to transmissions of signals along an over-the-air-path refers to wireless telecommunications. Wireless transmission modalities contemplated by the invention include but are not limited to radiofrequency transmissions, infrared transmissions, visual optical transmissions, microwave transmissions, and ultrasonic transmissions.

A “Functional Component” is a physical replacement part of the system that conforms to and provides an actual realization through a set of interfaces and instructions to computer circuits. It includes software interfaces that comprise all the source files, binary code, executables, scripts that are packaged for performing the intended functions through a set of electronic parts and circuit chips.

The term “digital audio CODEC” refers to an algorithm or component that can encode information from an analog audio signal as digital electrical signals, and or that can decode a digital electrical signal to prepare it for transformation to an analog waveform. In some embodiments it contains both an ADC and a DAC running off the same clock, as in a sound card.

“High-Fidelity” audio playback device in this application means a device that can produce “Lossless” audio with minimal distortion of the signal, that is capable of reproducing the full range of sound from recordings that have been mastered from better than 16-bit/44.1 kHz (CD quality) music sources.

The term “transmitter unit” is synonymous with wireless transmitter.

“Process” term in this application means coming up with a solution to functions, and a program, logic code or instructions for the solution.

Accordingly, functional blocks of the block diagrams and flowchart illustrations are the Components that support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose, hardware-based computer systems which perform the specified functions or steps, or suitable combinations of special purpose hardware and computer instructions.

For clarity reasons, all the necessary technology protocols and standards are used in the same way as an ordinary person in the art, and are therefore omitted herein. Necessary backgrounds information can be found on specific datasheet or in the standardized protocols.

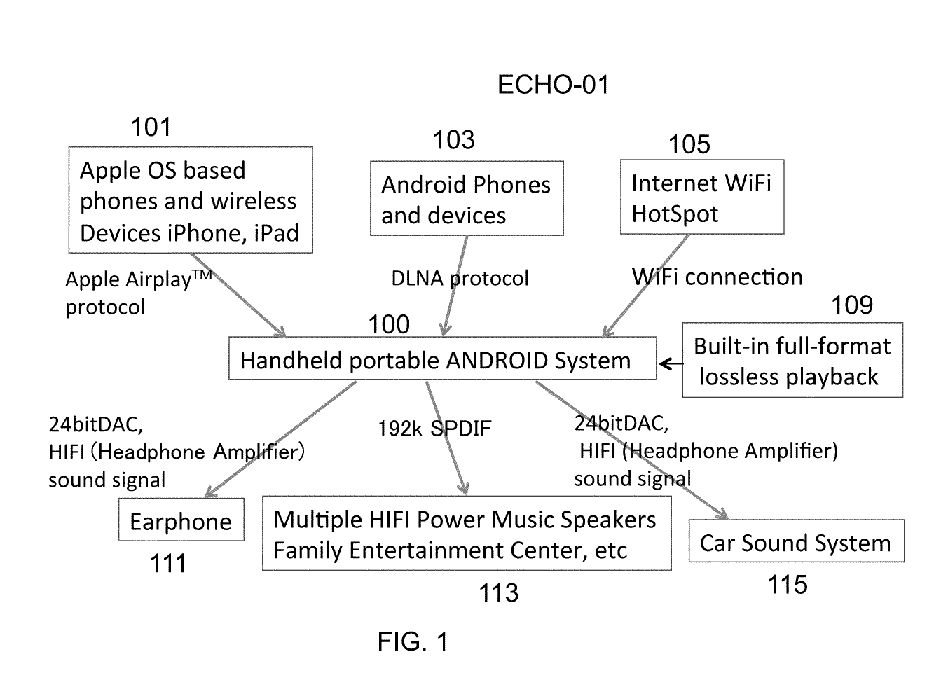

In reference to FIG. 1, system 100 for a portable high fidelity audio processing device can be implemented based on an Android operating system. Its control center can interact with a variety of devices and the Internet through Wi-Fi communication. System 100 receives and transmits Wi-Fi signals, through controlling its Wi-Fi compliant antenna, to and from the various data source devices, such as Apple OS based phones and iPad 101, Android based phones and tablets 103, internet Hotspot or a computer 105. Once a Wi-Fi signal is received, system 100 registers the sending device in its Wi-Fi connections network database. The connections to the various Wi-Fi enabled devices may be established simultaneously or one device at a time at a user's command. User input commands on system 100 are converted into Wi-Fi signals and transmitted to the various devices to which the Wi-Fi connections are established.

Based the Wi-Fi signals from the received device and the metadata of the received data packets, system 100 determines whether the data packets are transmitted in AIRPLAY or DLNA compliant format, and the corresponding decoding protocol will be selected to use for processing the incoming data streams.

The decoded data packets are then formatted either according to the 24 bit DAC PCM protocol (for example for an earphone 111 or built-in playback 109 or car sound system 115) or S/PDIF protocol (e.g. for a HiFi music speaker 113) to be played back according the user command. The formatted audio data are then amplified through a built-in high fidelity playback amplifying circuit, to be sent to a sound system to playback. It is contemplated that both the PCM and the DSD uncompressed audio data formats are supported, definitions of these data formats are in compliance to the ones used in audio processing field.

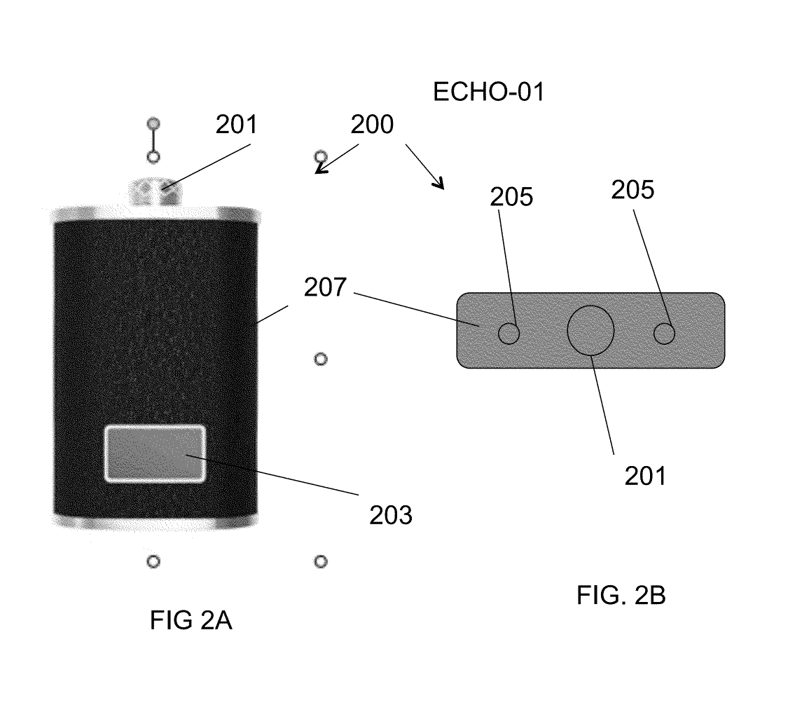

In reference to FIG. 2A and 2B, an example portable high fidelity audio processing device 200 includes both a traditional low-tech radio-like rotating knob 201 as well as a touch screen 203 disposed on the device body 207 to allow user interactions through simple intuitive mechanical actions. Radio-like rotating knob 201 may have a push to start mechanism for turn-on and off system power, and knob rotating to lock the device into a specific function. The combination of touch screen 203 and rotating knob 201 allows the most technology illiterate users, pre-school children, the un-educated, people with old age and disabilities to interact with high fidelity internet music with ease and elegance. Also included are plug-in sockets 205 for connecting to external sound systems.

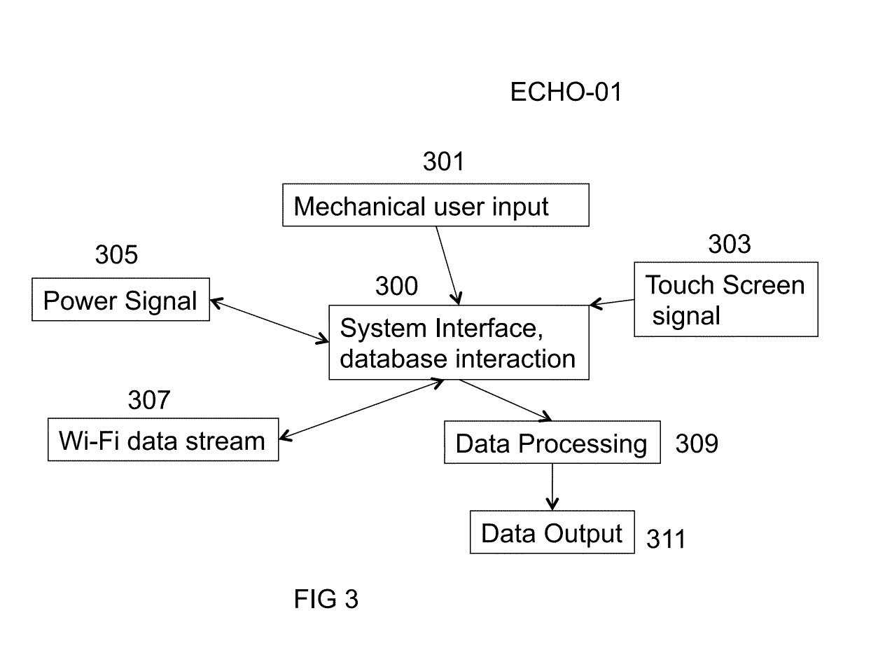

In reference to FIG. 3, system 100 of FIG. 1 for a portable high fidelity audio processing device contains a controlling module 300 for user interface interactions, Wi-Fi device data interactions, power control interactions and data output interactions. The mechanical rotating of a radio-like knob by a user at 301 is converted into corresponding electronic signals and corresponding user commands at central processing module 300. A user touch of the screen at the touch-screen display at 303 is converted into corresponding electronic signals and corresponding user commands at the central processing module 300. Central processing module 300 then performs the corresponding functions of the user commands by interacting with the power controlling module 305, the Wi-Fi data stream communication module 307 and the data processing module 309 and data output module 311.

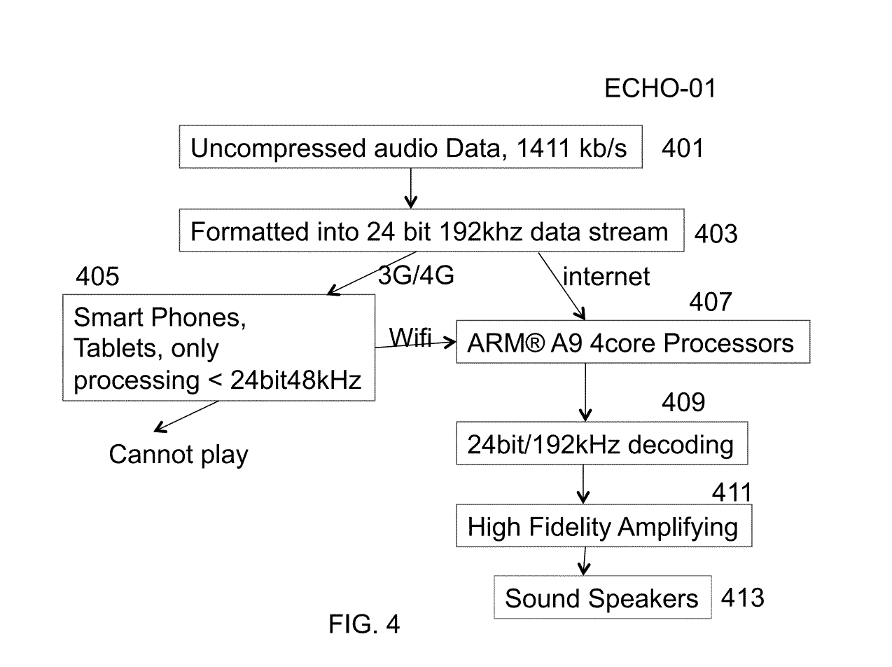

In reference to FIG. 4, a high resolution and high fidelity audio data processing is shown. Uncompressed audio data (maybe at 1411 kb/s) at 401 is likely to be transmitted as a 24 bit 192 kHz high density data stream at 403 for high fidelity effect. While the current smart phones and tablets do not possess the processing power due to size and capacity limitation, the 24 bit 192 kHz data stream can be transmitted to a powerful portable/handheld audio processing device system 100 of FIG. 1 through a Wi-Fi network or the Internet, in which a powerful and capable and dedicated computation processor 407 is equipped. Such audio processing device system 100 can be equipped with ARM A9 quad-core processors for decoding a 24 bit 192 kHz data stream at 409 and converting it into analog signals through a digital-to-analog converter and functions.

After sending the analog data stream to a high fidelity amplifying mechanism 411, the data stream are further sent to be played at the remote sound system 413. Thus the original audio data of 401 can be played lossless at a remote sound speaker 413. An example of high fidelity amplifying mechanism 411 is the Texas Instruments' PCM1792A2 digital to analog converter.

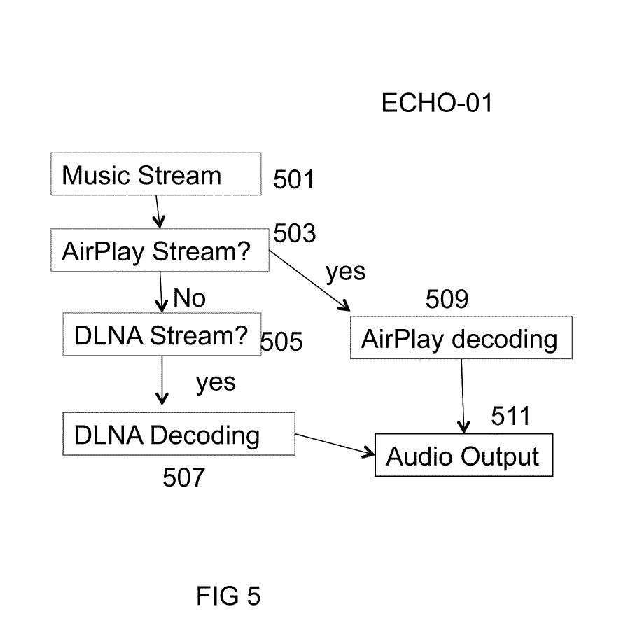

In reference to FIG. 5, a data stream decoding process is shown. When a media stream 501 is received by system 100 of FIG. 1, system 100 determines whether it is in AIRPLAY format, and retrieves the appropriate private key for decoding the data stream at 503. If the data format is AIRPLAY and the private key is then retrieved, system 100 decrypts the stream at 509 according to AIRPLAY protocol and coverts it into PCM and further into analog signals at 511. If the data stream is not in AIRPLAY format, the system then determines whether it is in DLNA (Digital Living Network Alliance) format that uses universal plug and play (UPnP) for media management, discovery and control. Data stream of DLNA is decoded accordingly, and in compliance to Internet Protocol (IP), HTTP, SOAP and XML.

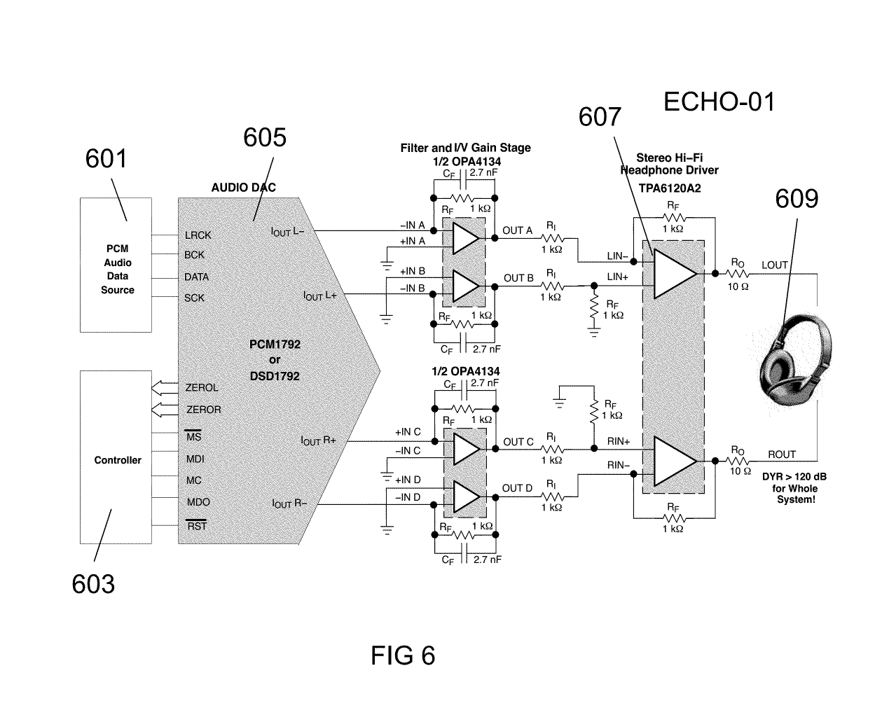

In reference to FIG. 6, a controlling process for high fidelity amplifying circuit is shown to playback decoded high fidelity audio data. System 100 contains a set of controlling module 603 that controls the performance of the DAC converting chip 605 and Hi-Fi headphone driver chip 607. The controlling process is thus encoded according to the manufactures datasheet and specification.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle. The claims as filed are intended to be as comprehensive as possible, and NO subject matter is intentionally relinquished, dedicated, or abandoned.

What is claimed is:

1. A method for establishing a user-friendly portable high fidelity audio system, comprising:
providing a portable audio data processing device having a rotatable knob for inputting user commands;
providing an interface and a plurality of functional components installed on said portable audio data processing device, said interface and plurality of functional components responding to said knob's rotation, wherein said plurality of functional components are a group of functional components selected from the functional components for controlling of Wi-Fi connections, searching the internet, and controlling of data output devices;
providing a plurality of audio decoding and encoding functional components on said portable audio data processing device, wherein said audio decoding and encoding functional components are configured to decode or encode high density audio data; and
providing a controlling functional component for sending a converted analog audio data file to a sound system.

2. The method of claim 1, wherein said audio decoding and encoding functional components include functional components configured to decode or encode high density audio data transmitted in either AIRPLAY format or DLNA format or to decode or encode AIRPLAY formatted data and DLNA formatted data simultaneously.

3. The method of claim 2, wherein said high density audio data are transmitted in 24 bit 192 k or higher.

4. The method of claim 1, wherein said audio decoding functional components include functional components configured to control data input and output of a high fidelity digital-to-analog converter.

5. The method of claim 4, wherein said high fidelity digital-to-analog converter is configured to generate S/PDIF formatted audio data.

6. The method of claim 1, wherein said interface and a plurality of functional components include searching and registering Wi-Fi signals from a surrounding environment.

7. The method of claim 6, wherein said Wi-Fi signals are received from an Apple OS based device.

8. The method of claim 6, wherein said Wi-Fi signals are received from an Android OS based device.

9. The method of claim 1, wherein said interface and a plurality of functional components also respond to a user input by a touch-screen.

10. The method of claim 1, wherein said interface and a plurality of functional components include functions for storing and retrieving Internet Radio channels.

11. A method for establishing a user-friendly portable high fidelity audio system, comprising:
providing a portable audio data processing device having a rotatable knob for inputting user commands; and
providing an interface and a plurality of functional components installed on said portable audio data processing device, said interface and plurality of functional components responding to said knob's rotation, wherein said plurality of functional components are a group of functional components selected from the functional components for controlling of Wi-Fi connections, searching the internet, and controlling of audio output devices.

12. The method of claim 11, wherein said interface and a plurality of functional components include a controlling functional component for sending a converted analog audio data file to a sound system.

13. The method of claim 11, wherein said interface and a plurality of functional components include a plurality of audio decoding and encoding functional components on said portable audio data processing device, wherein said audio decoding and encoding functional components are configured to decode or encode high density audio data.

14. The method of claim 13, wherein said audio decoding and encoding functional components include functional components configured to decode or encode high density audio data transmitted in either AIRPLAY format or DLNA format or to decode or encode AIRPLAY formatted data and DLNA formatted data simultaneously.

15. The method of claim 13, wherein said high density audio data are transmitted in 24 bit 192 k or higher.

16. The method of claim 11, wherein said interface and a plurality of functional components include functional components configured to control data input and output of a high fidelity digital-to-analog converter.

17. The method of claim 16, wherein said high fidelity digital-to-analog converter is configured to generate S/PDIF formatted audio data.

18. The method of claim 11, wherein said interface and a plurality of functional components include searching and registering Wi-Fi signals from a surrounding environment.

19. The method of claim 18, wherein said Wi-Fi signals are received from an Apple OS based device.

20. The method of claim 18, wherein said Wi-Fi signals are received from an Android OS based device.

21. The method of claim 11, wherein said interface and a plurality of functional components also respond to a user input by a touch-screen.

22. The method of claim 11, wherein said interface and a plurality of functional components include functions for storing and retrieving Internet Radio channels.

23. A user-friendly portable high fidelity audio device system, comprising:
a portable audio data processing device having a rotatable knob for inputting user commands; and
an interface and a plurality of functional components installed on said portable audio data processing device, said interface and plurality of functional components responding to said knob's rotation, wherein said plurality of functional components are a group of functional components selected from the functional components for controlling of Wi-Fi connections, searching the internet, and controlling of audio output devices.

24. The portable high fidelity audio device system of claim 23, wherein said interface and a plurality of functional components include a controlling functional component for sending a converted analog audio data file to a sound system.

25. The portable high fidelity audio device system of claim 23, wherein said interface and a plurality of functional components include a plurality of audio decoding and encoding functional components on said portable audio data processing device, wherein said audio decoding and encoding functional components are configured to decode or encode high density audio data.

26. The portable high fidelity audio device system of claim 25, wherein said audio decoding and encoding functional components include functional components configured to decode or encode high density audio data transmitted in either AIRPLAY format or DLNA format or to decode or encode AIRPLAY formatted data and DLNA formatted data simultaneously.

27. The portable high fidelity audio device system of claim 25, wherein said high density audio data are transmitted in 24 bit 192 k or higher.

28. The portable high fidelity audio device system of claim 23, wherein said interface and a plurality of functional components include functional components configured to control data input and output of a high fidelity digital-to-analog converter.

29. The portable high fidelity audio device system of claim 28, wherein said high fidelity digital-to-analog converter is configured to generate S/PDIF formatted audio data.

30. The portable high fidelity audio device system of claim 23, wherein said interface and a plurality of functional components include searching and registering Wi-Fi signals from a surrounding environment.

31. The portable high fidelity audio device system of claim 30, wherein said Wi-Fi signals are received from an Apple OS based device.

32. The portable high fidelity audio device system of claim 30, wherein said Wi-Fi signals are received from an Android OS based device.

33. The portable high fidelity audio device system of claim 23, wherein said interface and a plurality of functional components also respond to a user input by a touch-screen.

34. The portable high fidelity audio device system of claim 23, wherein said interface and a plurality of functional components include functions for storing and retrieving Internet Radio channels.
